(19) United States
(12) Patent Application Publication
(10) Pub. No.: US 2026/0171502 A1
(43) Pub. Date: Jun. 18, 2026

(54) ELECTROLYTE FOR LITHIUM METAL BATTERY AND LITHIUM METAL BATTERY INCLUDING THE SAME

(71) Applicants: HYUNDAI MOTOR COMPANY, SEOUL (KR); KIA CORPORATION, SEOUL (KR)

(72) Inventors: Kyuju Kwak, Hwaseong-si (KR); Ji Yong Lee, Hwaseong-si (KR); Sangheon Lee, Hwaseong-si (KR); Eunji Kwon, Hwaseong-si (KR); Yeonjong Oh, Hwaseong-si (KR); Jiho Lim, Hwaseong-si (KR); Dong Hyun Lee, Hwaseong-si (KR); Sangsu Lee, Hwaseong-si (KR); Kyoung Han Ryu, Hwaseong-si (KR); Samuel Seo, Hwaseong-si (KR)

(73) Assignees: HYUNDAI MOTOR COMPANY, SEOUL (KR); KIA CORPORATION, SEOUL (KR)

(21) Appl. No.: 19/420,710

(22) Filed: Dec. 15, 2025

(30) Foreign Application Priority Data
Dec. 16, 2024 (KR) 10-2024-0187679

(51) Int. Cl. H01M 10/0569; H01M 4/02; H01M 4/38; H01M 4/505; H01M 4/525; H01M 10/052; H01M 10/0568

(52) U.S. Cl. CPC H01M 10/0569; H01M 4/382; H01M 4/505; H01M 4/525; H01M 10/052; H01M 10/0568; H01M 2004/021; H01M 2300/0034; H01M 2300/0037

(57) ABSTRACT

An electrolyte for a lithium metal battery that includes a lithium salt; and a non-aqueous organic solvent where the non-aqueous organic solvent includes a main solvent and a cosolvent that is different from the main solvent.

### CROSS-REFERENCE TO RELATED APPLICATION

This application claims priority to and the benefit of Korean Patent Application No. 10-2024-0187679 filed with the Korean Intellectual Property Office on Dec. 16, 2024, the entire contents of which are incorporated herein by reference.

### FIELD

The disclosure relates to an electrolyte for a lithium metal battery and a lithium metal battery including the same.

### BACKGROUND

As the electric vehicle market grows, there is an increasing need for high-capacity batteries that surpass lithium ion batteries and accordingly, an increasing demand for negative and positive electrode materials with high energy density and high energy density and long-term stability of the lithium metal batteries.

Lithium metal, which has high capacity per weight of 3,860 mAh/g and a low standard electrode potential (−3.04 V vs normal hydrogen electrode), is attracting attentions as a negative electrode material for lithium secondary batteries. However, the lithium metal is highly reactive, creating an extremely reducing atmosphere during the charging process, which may cause an irreversible decomposition reaction between the lithium metal and an electrolyte. The decomposition reaction may deplete the electrolyte, wherein the decomposition products may form a nonuniform film on the lithium metal surface. In addition, the lithium grows in the form of dendrites, as charging and discharging are repeated. The dendritic lithium causes electrical short circuits inside the batteries, leading to safety issues (such as fires) of the batteries and the like.

Therefore, in order to apply lithium metal with high stability and high capacity, there is a need to develop an electrolyte that alleviates reactivity of lithium metal, prevents dendritic lithium growth, and enables uniform lithium electrodeposition (plating).

### SUMMARY

In one aspect, the disclosure provides an electrolyte for a lithium metal battery that can improve the durability of a lithium metal battery, for example, by delaying the decomposition of anions that constitute a lithium salt.

In some further embodiments, the disclosure provides a lithium metal battery having excellent stability.

According to an embodiment, an electrolyte for a lithium metal battery includes a lithium salt; and a non-aqueous organic solvent, wherein the non-aqueous organic solvent includes a main solvent and a cosolvent, wherein the main solvent includes N, N-dimethylsulfamoyl fluoride, ethylene carbonate, diethyl carbonate, dimethyl carbonate, ethyl methyl carbonate, 1,2-dimethoxy ether, dipropyl ether, cyclic sulfonamide, or a combination thereof, and the cosolvent comprises a compound of Chemical Formula 1.

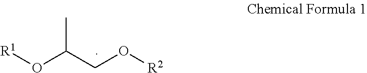

Wherein, in Chemical Formula 1,
R¹ and R² are each independently a methyl group or an ethyl group, provided that R¹ and R² are not both ethyl groups.

In some embodiments, the main solvent may be N, N-dimethylsulfamoyl fluoride.

In some embodiments, the cosolvent may be a compound in which, in Chemical Formula 1, R¹ and R² are each independently a methyl group.

In some embodiments, the cosolvent may be included in an amount of 24 mol % to 66 mol % based on a total amount of the non-aqueous organic solvent, (i.e., total amount of non-aqueous organic solvent being 100 mol %).

In some embodiments, the lithium salt and non-aqueous organic solvent may have a molar ratio of 1:2 to 1:2.5.

In some embodiments, the lithium salt may include at least one selected from Lithium bis(fluorosulfonyl)imide (LiFSI), Lithium (fluorosulfonyl) (nonafluorobutanesulfonyl)imide (LiFNFSI), and/or Lithium bis(trifluoromethanesulfonyl)imide (LiTFSI).

In some embodiments, the concentration of the above lithium salt may be 3.0 M to 5.0M.

According to another aspect, the disclosure provides a lithium metal battery comprising a positive electrode; a lithium metal layer as a negative electrode facing the positive electrode; a separator interposed between the positive electrode and the negative electrode; and the electrolyte for the lithium metal battery in accordance with the various embodiments of the disclosure.

In some embodiments, the lithium metal layer may have a thickness of 5 μm to 50 μm.

In some embodiments, the positive electrode may include a lithium-nickel-manganese-cobalt-based metal oxide.

According to various embodiments described herein, the electrolyte for the lithium metal battery can exhibit excellent stability by, for example, introducing a cosolvent capable of delaying the decomposition of a salt or solvent through local overconcentration, or reducing overvoltage by improving physical properties such as wettability and volatility, in combination with a specific type of main solvent. As such, the disclosure provides a lithium metal battery, including the electrolyte herein, that can have improved durability performance.

### BRIEF DESCRIPTION OF THE DRAWINGS

FIG. 1 shows the results of evaluating the durability characteristics of a lithium metal battery cells using each electrolyte according to Example 1 and Comparative Example 1.

FIG. 2a is the same as the graph shown in FIG. 1, and FIGS. 2B and 2C show the results of F-NMR quantitative analysis before and after operation of a lithium metal battery cells using each electrolyte according to Comparative Example 1 and Example 3, respectively.

FIG. 3A shows the results of evaluating the durability characteristics of the lithium metal battery cells using each electrolyte according to Comparative Examples 1 and 2, FIG. 3B shows the results of F-NMR quantitative analysis before and after operation of the lithium metal battery cell using the electrolyte according to Comparative Example 2, and FIG. 3C shows the results of evaluating the durability characteristics of the lithium metal battery cells using each electrolyte according to Comparative Examples 1 and 4.

FIG. 4A is a Raman spectroscopy analysis diagram of the lithium metal battery cells using each electrolyte according to Comparative Example 1 and Comparative Example 2, and FIG. 4B is a Raman spectroscopy analysis diagram of the lithium metal battery cells using each electrolyte according to Comparative Example 1 and Example 1.

FIGS. 5A and 5B show Tafel analysis graphs of the lithium metal battery cells using each electrolyte according to Comparative Examples 1 and 3.

FIG. 6A shows the results of evaluating durability characteristics of the lithium metal battery cells using each electrolyte according to Comparative Example 1 and Example 2, FIG. 6B shows the results of evaluating durability characteristics of the lithium metal battery cells using each electrolyte according to Comparative Example 1, Example 3, and Example 4, FIG. 6C shows the results of evaluating durability characteristics of the lithium metal battery cells using each electrolyte according to Comparative Example 1 and Comparative Example 5, and FIG. 6D shows the results of evaluating durability characteristics of the lithium metal battery cells using each electrolyte according to Comparative Example 1 and Comparative Example 6.

FIG. 7A shows the results of evaluating the durability characteristics of the lithium metal battery cells using each electrolyte according to Example 1 and Example 5, and FIG. 7B shows the results of evaluating the durability characteristics of the lithium metal battery cells using each electrolyte according to Example 1 and Comparative Example 7.

FIG. 8 shows the results of evaluating the durability characteristics of the lithium metal battery cells using each electrolyte according to Examples 3, 6, 7, and Comparative Examples 8 to 10.

### DETAILED DESCRIPTION OF THE EMBODIMENTS

The above and other objects, features and advantages of the present disclosure will be more clearly understood from the following aspects and embodiments taken in conjunction with the accompanying drawings. However, neither the present disclosure nor the claims are limited to the embodiments disclosed herein, and may be modified into different forms in accordance with the guidance provided herein. The example aspects and embodiments are provided herein in an effort to thoroughly explain the various features of the disclosure and to convey the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise” or “comprising”, “include” or “including”, “have” or “having”, etc., when used in this specification, specify the presence of stated features, integers, steps, operations, elements, components, or combinations thereof, but do not preclude the presence or addition of one or more other features, integers, steps, operations, elements, components, or combinations thereof. In some aspects and embodiments, these terms should be understood to encompass the terms “consisting of” and “consisting essentially of” which refer to features, integers, numbers, steps, operations, elements, components, parts, or combinations thereof that only include the recited components, or the recited components allowing for minor amounts of other components or elements that do not have a material effect on the function of the recited feature, component, embodiment, or aspect of the disclosure. Thus, some aspects and embodiments may refer to these various transitionary terms, all of which form part of the disclosure.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Furthermore, unless specifically stated otherwise, the term “about” as used or implied herein may be understood within a range of error that is typical in the art (e.g., within 2 standard deviations of the mean). “About” may be understood as within 10%, 9%, 8%, 7%, 6%, 5%, 4%, 3%, 2%, 1%, 0.5%, 0.1%, 0.05%, or 0.01% of the stated value.

As used herein, the term “combination(s) thereof” described in a listing of components (e.g., either “comprising” or a “consisting of” Markush group) refers to one or more mixtures or combinations selected from the components described in the expression in the recited component(s) (e.g., Markush group), and refers to including at least one selected from the components.

Hereinafter, the various embodiments will be described in greater detail, and in which certain exemplary embodiments are illustrated. As those skilled in the art will appreciate, the described embodiments may be modified in various different ways, all without departing from the spirit or scope of the present embodiment.

### <Electrolyte for Lithium Metal Battery>

Efforts to develop new compositions of electrolyte (salt type, salt concentration, additives, etc.) to improve the durability of lithium metal batteries are being actively pursued. The disclosure relates to technology capable of improving durability characteristics by controlling the composition of the solvent, for example, by introducing a new type of cosolvent into a main solvent, and thus delaying the decomposition of salts and solvents in an electrolyte.

According to an embodiment, the disclosure provides a non-aqueous organic solvent in an electrolyte for a lithium metal battery that comprises a main solvent and a cosolvent. In such embodiments, including a cosolvent of a particular type, amount, and molar ratio with respect to a lithium salt, that are controlled in the electrolyte, provide several advantages including, for example, i) local overconcentration is implemented to delay decomposition of a salt or solvent, and at the same time ii) physical properties such as wettability and volatility are improved to reduce overvoltage.

In some embodiments, the cosolvent may include perfluorinated ether-based solvents with a wide voltage range. Some representative non-limiting examples may include 1,1,2,2-tetrafluoroethyl-2,2,3,3-tetrafluoropropyl ether (denoted by TTE), bis(2,2,2-trifluoroethyl) ether (denoted by BTFE), and 1,1,2,2-tetrafluoroethyl-1H, 1H,5H-octafluoropentyl ether (denoted by TFOFE).

According to an embodiment, the main solvent in the non-aqueous organic solvent may include N,N-dimethylsulfamoyl fluoride, ethylene carbonate, diethyl carbonate, dimethyl carbonate, ethyl methyl carbonate, 1,2-dimethoxy ether, dipropyl ether, cyclic sulfonamide, or a combination thereof. Among these, when the electrolyte for the lithium metal battery includes N, N-dimethylsulfamoyl fluoride as a solvent, it has been observed that continuous salt deterioration can be a major cause of battery durability deterioration. These observations demonstrate that the electrolyte environment that allows for easy oxidation of anions represents a technological challenge that must be addressed for improving high-voltage batteries.

While various additives are being developed to delay the deterioration discussed above, the instability of the protective film can cause continuous consumption of the additives and increases electrode resistance, thereby hindering the output characteristics. Therefore, there have been attempts to induce agglomeration of salt-solvent, and suppress decomposition of salt and solvent by applying a perfluorinated ether-based cosolvent. This agglomeration phenomenon, however, increases the negative electrode reactivity of lithium salt, causing reductive decomposition. As perfluorinated solvents have a low degree of dissociation for lithium salts, it is difficult to implement a high-concentration electrolyte, which in turn, reduces the absolute amount of salt in the electrolyte. This creates a continuous consumption that reacts with lithium metal to form a film, and has made this approach difficult to adopt as a commercialization strategy. Therefore, there remains a need in the lithium metal battery field for the development of an additive cosolvent that 1) dissociates excess lithium salts to increase the amount of salt dissolved in the electrolyte, 2) suppresses salt decomposition, and/or 3) has a lasting effect because it does not decompose in the electrode reaction.

As described in the various aspects and embodiments that follow, it has been surprisingly found that by adding a cosolvent of Chemical Formula 1 to a main solvent including N,N-dimethylsulfamoyl fluoride, ethylene carbonate, diethyl carbonate, dimethyl carbonate, ethyl methyl carbonate, 1,2-dimethoxy ether, dipropyl ether, cyclic sulfonamide, or a combination thereof, the modified solvent makes it possible to introduce additional salts, delay the decomposition of the FSI anion (an anion of a lithium salt), thereby contributing to improving the durability of a lithium metal battery. These aspects and embodiments provide an electrolyte for a lithium metal battery which is stable to lithium metal, thus limiting certain reactions and allowing from improved stability.

In some embodiments, the cosolvent comprises Chemical Formula 1

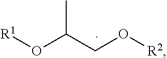

wherein, in Chemical Formula 1,
R¹ and R² are each independently a methyl group or an ethyl group, provided that R¹ and R² are not both ethyl groups.

The electrolyte for the lithium metal battery according to an embodiment of the disclosure includes a lithium salt; and a non-aqueous organic solvent. As described herein, the non-aqueous organic solvent may include a main solvent and a cosolvent, wherein the main solvent may include N,N-dimethylsulfamoyl fluoride, ethylene carbonate, diethyl carbonate, dimethyl carbonate, ethyl methyl carbonate, 1,2-dimethoxy ether, dipropyl ether, cyclic sulfonamide, or a combination thereof, and the cosolvent may include a according to Chemical Formula 1.

As described herein, incorporating a cosolvent according to Chemical Formula 1 with the main solvent, the resulting non-aqueous organic solvent is stable to lithium metal, and thus, allows for the preparation of a highly stable electrolyte.

In some embodiments, the main solvent may be N,N-dimethylsulfamoyl fluoride, and the cosolvent may be a compound in which R¹ and R² in Chemical Formula 1 are each independently a methyl group, i.e., 1,2-dimethoxypropane. In some embodiments, the cosolvent may be included in an amount of 24 mol % to 66 mol % based on a total amount of the non-aqueous organic solvent, i.e., 100 mol %.

In some embodiments, the lithium salt and the non-aqueous organic solvent of the composition may have a molar ratio ranging from 1:2 to 1:2.5.

In embodiments wherein the type and amount of the cosolvent and the molar ratio of the lithium salt and the non-aqueous organic solvent are controlled as described above, the resulting electrolyte can exhibit extremely improved stability and delay the decomposition of the lithium salt due to oxidation and reduction.

The combination of main solvent and cosolvent to for the non-aqueous organic solvent provides substantial advantages compared to using either a main solvent or a cosolvent alone. For example, when N,N-dimethylsulfamoyl fluoride, a solvent participating in the formation of a negative electrode film, is used solely as a non-aqueous organic solvent (without any cosolvent), salt reductive decomposition at the negative electrode is observed due to low electrochemical reduction stability of the salt derived from the use of a weakly dissolving solvent. This reduces the film-forming effect of N, N-dimethylsulfamoyl fluoride, and requires a strategy for improving durability in order to counter the accelerated deterioration caused by a decrease in salt concentration. Conversely, when a cosolvent represented by Chemical Formula 1 is introduced with the main solvent, the resulting solvent can achieve the inhibition of salt decomposition and introduction of an absolute excess of salt.

Similarly, when a cosolvent of Chemical Formula 1 is used solely as a solvent (without an additional main solvent), it has a weaker dissolution structure than an electrolyte using a conventional ether-based solvent alone, which may limit the lithium negative electrode reaction of the solvent. However, due to the low electrochemical oxidation stability of the salt derived from a stronger dissolution structure (i.e., than the N, N-dimethylsulfamoyl fluoride), salt oxidation decomposition at the positive electrode is observed, which leads to an increase in positive electrode resistance and salt depletion due to positive electrode film formation. One way to address this problem is to induce inhibition of salt decomposition and input an absolute excess of salt. The above problems can be addressed by the electrolyte composition according to embodiments described herein.

In accordance with some particular embodiments of the disclosure, a non-aqueous organic solvent is also prepared by using 1,2-dimethoxyethane, which is commonly used as an ether-based solvent, as the main solvent, and 1,1,2,2-tetrafluoroethyl-2,2,3,3-tetrafluoropropyl ether denoted by TTE, which is a commonly used cosolvent as described above. In this embodiment, and without being limited by any mechanism, it appears to provide an advantage in that it creates structural agglomeration in the electrolyte, thereby delaying the oxidative decomposition of the electrolyte, and improving the limitations of ionic conductivity and viscosity. The composition, however, has technological challenges in that the salt concentration is reduced by reductive decomposition of the salt, and when excessive amount is added to find the optimal dissolution environment, the salt is precipitated due to low salt dissociation, making it difficult to control the amount of the salt. In addition, the film-forming effect of the solvent including only N, N-dimethylsulfamoyl fluoride deteriorates due to the chemical reaction at the negative electrode caused by the low LUMO energy level of the cosolvent, making it difficult to observe continuous performance improvement.

In contrast to the above challenges, in accordance with embodiments, the composition of the electrolyte described herein is that 1) increases the amount of a salt with delayed decomposition, and 2) has low reactivity toward a lithium negative electrode and thus exhibits a lasting effect. This can be expected to improve durability by delaying salt depletion without inhibiting the effect of a solvent participating in the formation of a negative electrode film having the composition of the electrolyte, such as one including N, N-dimethylsulfamoyl fluoride alone.

Thus, in some embodiments wherein the main solvent includes N,N-dimethylsulfamoyl fluoride, the cosolvent represented by Chemical Formula 1 should 1) form a good dissolution environment to suppress oxidation/reductive decomposition of the salt, 2) have excellent salt solubility so that they can be mixed into the solvent to dissociate an excess salt, and 3) be stable to lithium metal. In some preferred embodiments the non-aqueous organic solvent comprises 1,2-dimethoxypropane as the cosolvent.

Ultimately, by using an electrolyte having a composition in accordance with the aspects and embodiments herein, it is possible to improve the durability of a lithium metal battery using the electrolyte.

According to an embodiment, the lithium salt may include at least of lithium bis(fluorosulfonyl)imide (denoted by LiFSI), lithium (fluorosulfonyl) (nonafluorobutanesulfonyl)imide (denoted by LiFNFSI), lithium bis(perfluoroethylsulfonyl)imide (denoted by LiBETI), and lithium bis(trifluoromethanesulfonyl)imide (denoted by LiTFSI). In some specific embodiments, the lithium salt may be LiFSI.

In some embodiments, the concentration of the lithium salt included in the electrolyte for the lithium metal battery may be from 3.0 M to 5.0 M, and, in some more specific embodiments may be from 3.1 M to 4.9 M.

In contrast with the embodiments above, if the concentration of the lithium salt is below the above ranges, the conductivity of the electrolyte may decrease, which may result in poor electrolyte performance, and if the concentration of the lithium salt exceeds the above range, the viscosity of the electrolyte may increase, which may result in reduced mobility of lithium ions and potential overvoltage occurring from the beginning of the cycle. Further, lithium salts outside of the above ranges can lead to an undesirable SEI layer formed on the surface of the lithium metal, which is the negative electrode, which is not formed at all or that forms a film that is too thick, which may lower the electrochemical performance of the lithium metal battery.

### <Lithium Metal Battery>

Another aspect of the disclosure provides a lithium metal battery including the electrolyte for a lithium metal battery as described above.

In some embodiments, the lithium metal battery may include a positive electrode, a lithium metal layer as a negative electrode facing the positive electrode, a separator interposed between the positive electrode, and the negative electrode and the electrolyte for a lithium metal battery.

In embodiments, the negative electrode for a lithium metal battery may be a lithium metal layer, and the lithium metal layer itself may be used as a negative electrode for a battery.

In accordance with this aspect, a battery including the negative electrode may allow lithium ions from the positive electrode to move to the negative electrode to form a lithium metal layer when charged. Charging and discharging of the battery may be proceeded by forming or removing this lithium metal layer.

In embodiments, the negative electrode may be formed on a negative electrode current collector such as copper.

In embodiments, the lithium metal layer may have a thickness of 5 μm to 50 μm, for example, 10 μm to 50 μm or may be formed to have the above thickness.

In embodiments, wherein the lithium metal layer satisfies the above thickness, side reactions between the lithium metal layer and the electrolyte may be suppressed, thereby improving the electrochemical performance of the lithium metal battery.

In another embodiment, the positive electrode is disposed opposite the negative electrode.

In embodiments, the positive electrode may include a positive electrode current collector and a positive electrode active material layer formed on the positive electrode current collector.

In embodiments, the positive electrode collector may be made of stainless steel, aluminum, nickel, titanium, calcined carbon, or aluminum or stainless steel surface-treated with carbon, nickel, titanium, silver, etc.

In embodiments, the thickness of the positive electrode collector may be 3 μm to 500 μm.

In embodiments, the positive electrode active material layer includes a positive electrode active material.

In embodiments, the positive electrode active material may be a compound capable of reversibly intercalating and deintercalating lithium, and in some specific embodiments, may include lithium iron phosphate. In embodiments wherein the positive electrode active material includes lithium iron phosphate, the compatibility with the aforementioned electrolyte may be particularly effective, providing for a maximized improvement in battery performance.

In embodiments, the positive electrode active material may be a compound capable of reversibly intercalating and deintercalating lithium, and, in some specific embodiments, may include a lithium metal oxide including at least one of cobalt, manganese, nickel, and aluminum. In some specific embodiments, the lithium metal oxide may include at least one of a lithium-manganese-based oxide, a lithium-cobalt-based oxide, a lithium-nickel-based oxide, a lithium-nickel-manganese-based oxide, a lithium-nickel-cobalt-based oxide, a lithium-manganese-cobalt-based oxide, a lithium-nickel-manganese-cobalt-based oxide, a lithium-manganese-cobalt-based oxide, or a lithium-nickel-cobalt-transition metal (M) oxide.

In embodiments, the positive electrode active material may be a lithium-nickel-manganese-cobalt-based oxide, and which may specifically improve the capacity characteristics and stability of the battery. In some particular embodiments, the lithium-nickel-manganese-cobalt-based oxide may be represented by Chemical Formula 2.

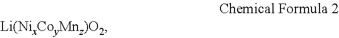

wherein in Chemical Formula 1,

$$0 \leq x \leq 1 , 0 \leq y \leq 1 , 0 \leq z \leq 1 , and x + y + z = 1.$$

In some embodiments, the positive electrode active material layer may further include a binder and/or a conductive material.

In some embodiments, the separator separates the negative electrode and the positive electrode and provides a passage for lithium ions to move, and is not particularly limited as long as it is a separator commonly used in lithium secondary batteries.

The following working examples illustrate the present embodiment in more particular detail. However, the following examples only provide illustrative embodiments, which are not limiting to the scope of the disclosure or claims.

### Example: Preparation of Electrolyte for Lithium Metal Battery

After preparing an electrolyte by adding LiFSI salt to a non-aqueous organic solvent to dissociate it, calcium hydride (denoted by CaH₂) was added thereto in an amount of greater than or equal to 1% of a total weight of a sample and after 30 minutes was removed, to obtain an electrolyte for a lithium metal battery.

In Tables 1 and 2, electrolyte compositions for a lithium metal battery according to examples and comparative examples are shown.

TABLE 1

| | | | Cosolvent (mol % | |
|---|---|---|---|---|
| | | | based on a total | Molar ratio between |
| | | | amount of non- | lithium salt and non- |
| | | | aqueous organic | aqueous organic |
| | Salt | Main solvent | solvent) | solvent |
| Example 1 | LiFSI | N,N-dimethylsulfamoyl | 1,2-dimethoxypropane | 1:2.5 |
| | | fluoride | (30 mol %) | |
| Example 2 | LiFSI | N,N-dimethylsulfamoyl | 1,2-dimethoxypropane | 1:2.5 |
| | | fluoride | (66 mol %) | |
| Example 3 | LiFSI | N,N-dimethylsulfamoyl | 1,2-dimethoxypropane | 1:2.5 |
| | | fluoride | (49 mol %) | |
| Example 4 | LiFSI | N,N-dimethylsulfamoyl | 1,2-dimethoxypropane | 1:2.5 |
| | | fluoride | (24 mol %) | |
| Example 5 | LiFSI | N,N-dimethylsulfamoyl | 1,2-dimethoxypropane | 1:2 |
| | | fluoride | (30 mol %) | |
| Example 6 | LiFSI | N,N-dimethylsulfamoyl | 1-ethoxy-2- | 1:2.5 |
| | | fluoride | methoxypropane | |
| | | | (49 mol %) | |
| Example 7 | LiFSI | N,N-dimethylsulfamoyl | 2-ethoxy-1- | 1:2.5 |
| | | fluoride | methoxypropane | |
| | | | (49 mol %) | |

TABLE 2

| | | | Cosolvent | |
|---|---|---|---|---|
| | | | (mol % based on a | Molar ratio between |
| | | | total amount of non- | lithium salt and non- |
| | | | aqueous organic | aqueous organic |
| | Salt | Main solvent | solvent) | solvent |
| Comparative | LiFSI | N,N- | — | 1:2 |
| Example 1 | | dimethylsulfamoyl | | |
| | | fluoride | | |
| Comparative | LiFSI | 1,2- | — | 1:2 |
| Example 2 | | dimethoxypropane | | |
| Comparative | LiFSI | 1,2- | — | 1:2 |
| Example 3 | | dimethoxyethane | | |
| Comparative | LiFSI | 1,2- | 1,1,2,2- | 1:2 |
| Example 4 | | dimethoxypropane | tetrafluoroethyl- | |
| | | | 2,2,3,3- | |
| | | | tetrafluoropropyl ether | |
| | | | (30 mol %) | |
| Comparative | LiFSI | N,N- | 1,2-dimethoxypropane | 1:25 |
| Example 5 | | dimethylsulfamoyl | (5 mol %) | |
| | | fluoride | | |
| Comparative | LiFSI | N,N- | 1,2-dimethoxypropane | 1:2.5 |
| Example 6 | | dimethylsulfamoyl | (76 mol %) | |
| | | fluoride | | |
| Comparative | LiFSI | N,N- | 1,2-dimethoxypropane | 1:3 |
| Example 7 | | dimethylsulfamoyl | (30 mol %) | |
| | | fluoride | | |
| Comparative | LiFSI | N,N- | 1,2-dimethoxybutane | 1:2.5 |
| Example 8 | | dimethylsulfamoyl | (49 mol %) | |
| | | fluoride | | |
| Comparative | LiFSI | N,N- | 1,2-diethoxypropane | 1:2.5 |
| Example 9 | | dimethylsulfamoyl | (49 mol %) | |
| | | fluoride | | |
| Comparative | LiFSI | N,N- | 1,2-dipropoxypropane | 1:2.5 |
| Example 10 | | dimethylsulfamoyl | (49 mol %) | |
| | | fluoride | | |

Performance Confirmation of Lithium Metal Battery Cell with Electrolyte Including a Solvent for Controlling the Dissolution Environment-1

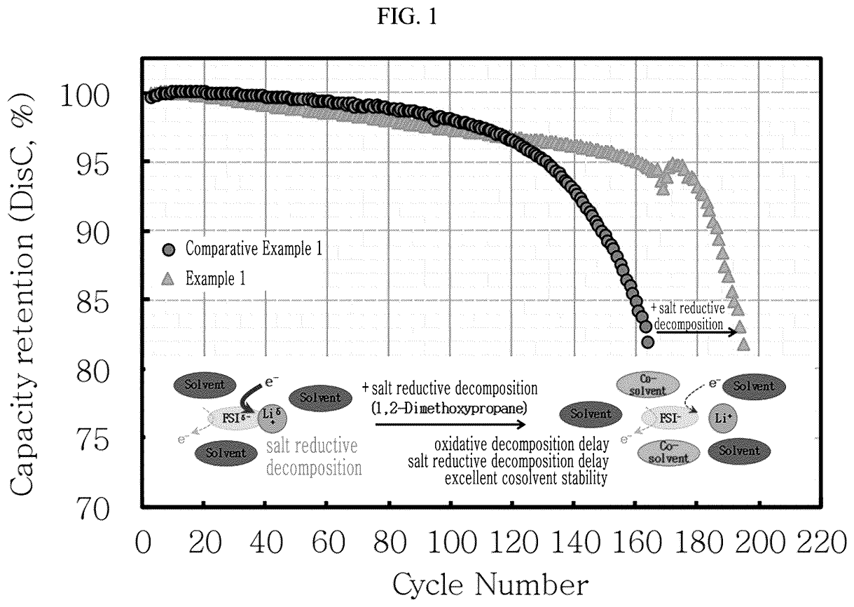

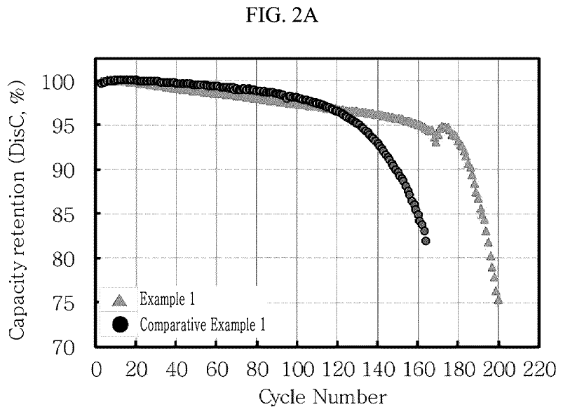

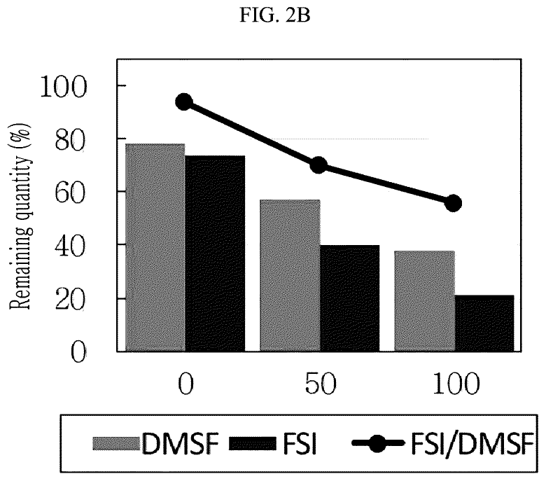

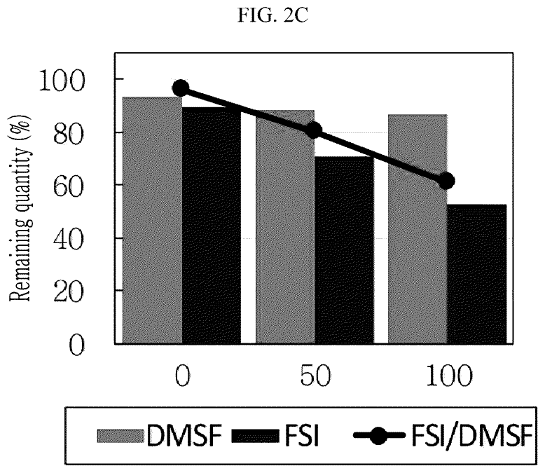

(1) A Li/NMC lithium metal battery cell including the electrolyte of Example 1 was confirmed to exhibit durability (197 times) increased by 18%, compared to that (167 times) of a lithium metal battery cell including the electrolyte of Comparative Example 1, which included no cosolvent. This can be observed from FIG. 1 and FIG. 2A.

(2) The cells were subjected to ¹⁹F-NMR analysis to identify a deterioration factor in the electrolytes. Specifically, the ¹⁹F-NMR analysis was performed by injecting 2.5 g/Ah of each of the electrolytes into a 0.169 Ah bi-cell under the same evaluation conditions as in FIG. 1 and 50 cycles and 100 cycles charging/discharging the cell to take a sample. 100 μL of the sample was taken by cutting each top portion of the pouch cell, injecting 1 mL of DME into the pouch cell to wash residual electrolyte, and then, 900 μL of a mixed solution of 30 g of d6-DMSO as an NMR solvent and 5 g of fluorobenzene as an internal standard solution was injected into the sample to measure ¹⁹F-NMR (500 MHz, Unity Inova, Varian Technology). As a result of the 19F-NMR measurement, DMSF/FSI (mol) and FSI/fluorobenzene (mol) were calculated by reading areas of DMSF, FSI, and fluorobenzene signals, and then, DMSF/fluorobenzene (mol) was calculated by multiplying them. Through this, the solvent and salt remaining in the electrolyte after the battery reaction were quantified.

(3) As a result of an NMR quantitative analysis of Comparative Example 1, a rapid concentration decrease of the FSI salt was observed. This can be observed from FIG. 2B. It is believed that its main cause was reductive decomposition of the salt, which was previously predicted to be characteristic of a weak dissolving solvent.

(4) The NMR analysis result of Example 3, including an 1,2-dimethoxypropane (DMP) cosolvent, confirmed that a large absolute amount of the FSI salt was present in the electrolyte, which still included excessive FSI even after 100 charge/discharge cycles. This can be observed in FIG. 2C. Table 3 shows NMR quantitative analysis results of Comparative Example 1 and Example 3.

TABLE 3

| | | | | | | | FSI remaining | | DMSF remaining | |
|---|---|---|---|---|---|---|---|---|---|---|
| | DMSF/FSI (mol) | | FSI/fBz (mol) | | DMSF/fBz (mol) | | amount (%) | | amount (%) | |
| | Comparative | | Comparative | Example | Comparative | Example | Comparative | Example | Comparative | Example |
| | Example 1 | Example 3 | Example 1 | 3 | Example 1 | 3 | Example 1 | 3 | Example 1 | 3 |
| Fresh | 0.337 | 0.810 | 10.023 | 0.025 | 0.068 | 0.031 | — | — | — | — |
| 0 cycle | 0.316 | 0.780 | 0.017 | 0.022 | 0.053 | 0.029 | 73.5 | 89.7 | 78.3 | 93.1 |
| 50 cycles | 0.236 | 0.650 | 0.009 | 0.018 | 0.038 | 0.027 | 39.8 | 71.1 | 56.9 | 88.6 |
| 100 cycles | 0.188 | 0.495 | 0.005 | 0.013 | 0.028 | 0.027 | 21.0 | 53.0 | 37.7 | 86.7 |

DMSF: N,N-dimethylsulfamoyl fluoride(N,N-dimethylsulfamoyl fluoride)
*FSI: bis(fluorosulfonyl)imide
*fBz: fluorobenzene

(5) Lastly, experiments confirmed that the durability of a lithium metal battery was able to be improved by increasing an amount of a salt and delaying decomposition of the salt.

Performance Confirmation of Lithium Metal Battery Cell with Electrolyte Including a Solvent for Controlling the Dissolution Environment-2

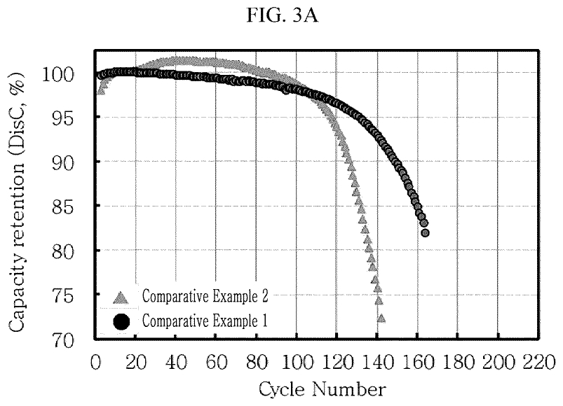

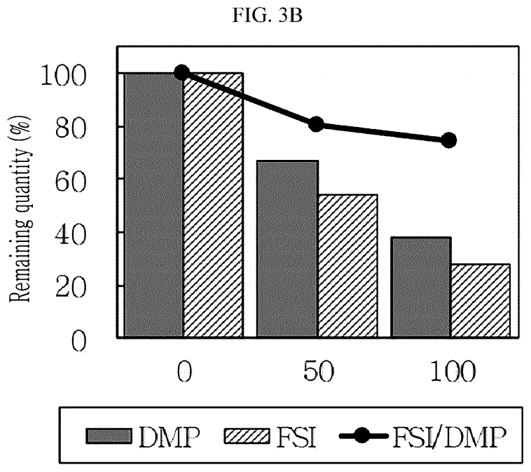

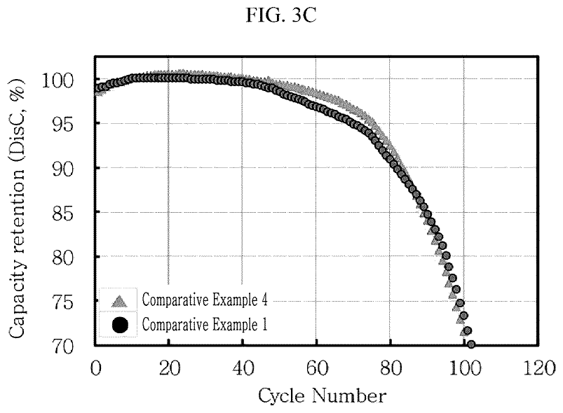

(1) Comparative Example 2 incorporates an electrolyte using the cosolvent of Example 1 as a solvent, which was a strong dissolving solvent electrolyte. A Li/NMC lithium metal battery cell including the electrolyte of Comparative Example 2 exhibited durability of 137 times, which was reduced by 18% from 167 times of the lithium metal battery cell including the electrolyte of Comparative Example 1. This can be confirmed from FIG. 3A. The data suggests that when a strong dissolving solvent electrolyte was used as a solvent, the higher salt dissociation, the longer distance of Li-FSI, which made the salt more anionic and thereby, made electrochemical oxidative decomposition easier.

(2) When the residual components were quantified through NMR, it was observed that the FSI amount rapidly decreased, as illustrated in FIG. 3B. The NMR quantitative analysis result of Comparative Example 2 is shown in Table 4.

TABLE 4

| | | | | FSI remaining |
|---|---|---|---|---|
| # of cycle | FSI/dfBz (mol) | DMP/dfBz | FSI/DMP | amount |
| 0 | 0.026 | 0.082 | 0.31 | 100.0 |
| 50 | 0.014 | 0.055 | 0.25 | 53.8 |
| 100 | 0.007 | 0.0 | 0.23 | 26.9 |

*DMP: 1,2-dimethoxypropane
*FSI: bis(fluorosulfonyl)imide
*dfBz: difluorobenzene

(3) The data also shows that too strong of a strong dissolving solvent failed to contribute to improving durability, but using a suitably strong dissolving solvent with a cosolvent, rather than alone, was effective to improve the durability.

(4) The electrolyte composition of Comparative Example 4, prepared by incorporating a perfluorinated cosolvent, which weakened the dissolution environment, exhibited a greater improvement in durability than that of Comparative Example 1, which was prepared without adding the cosolvent, but was confirmed to have the durability level of Comparative Example 1 as its limit. This can be observed from FIG. 3C.

(5) The experimental data confirmed that a combination of a solvent and a cosolvent was capable of creating an appropriate dissolution environment.

Performance Confirmation of Lithium Metal Battery Cell with Electrolyte Including a Solvent for Controlling the Dissolution Environment-3

(1) Raman spectroscopy was performed to analyze the dissolution state of FSI anions to confirm the dissolution environment of the working examples.

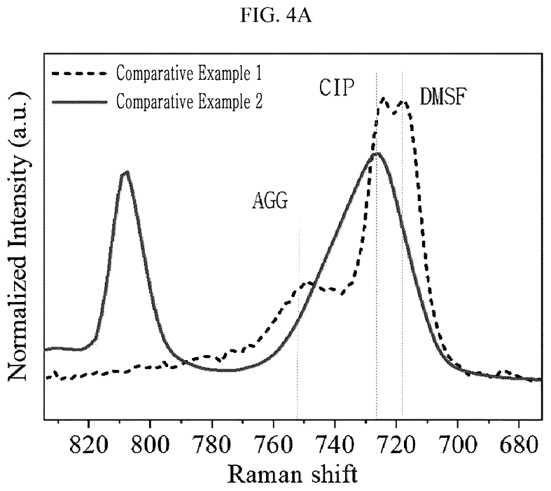

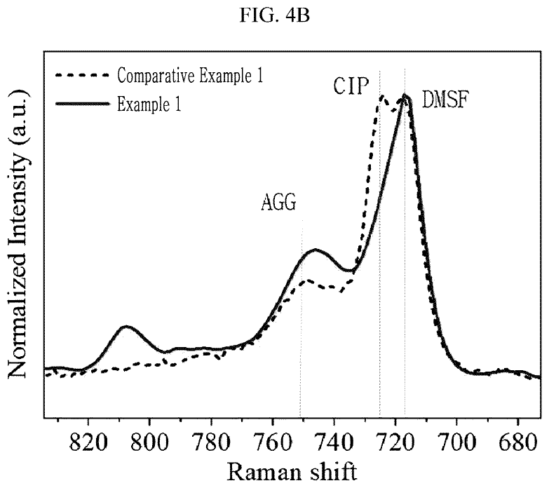

(2) Comparative Example 1, using a weak dissolving solvent, exhibited outstanding aggregate ion pairs denoted by AGG and contact ion pairs denoted by CIP, likely due to low dissociation of the salt. Comparative Example 2, using a strong dissolving solvent, however, mostly exhibited CIP due to high dissociation of the salt. This can be confirmed from the data in FIG. 4A.

(3) In contrast, Example 1 exhibited that CIP decreased, but AGG increased. This can be confirmed from the data in FIG. 4B.

(4) Accordingly, even when incorporating a strong dissolving solvent as a cosolvent to a weak dissolving electrolyte, that data suggests that, rather than any intermediate characteristic, a third characteristic is expressed and creates a favorable dissolution environment. Accordingly, the embodiment in the example acts as a novel composition expressing new characteristics, rather than simply adopting a solvent and simply mixing it to achieve an intermediate mixed characteristic.

### Lithium Stability of Cosolvent

(1) The durability of a lithium metal battery is primarily deteriorated when a lithium negative electrode having a high reactivity participates in a chemical side reaction with an electrolyte, which depletes the electrolyte and increases resistance. The solvent in the electrolyte of Comparative Example 1, N, N-dimethylsulfamoyl fluoride (DMSF), is known to react with lithium, typically forming high ion conductive SEI through the reaction, increasing cycle-life of a battery. However, because the electrolyte was a weak dissolving electrolyte, the salt reacted with the negative electrode, inhibiting DMSF from forming the high ion conductive film, and in addition, the electrolyte was depleted during the long-term operation, increasing resistance of the solution.

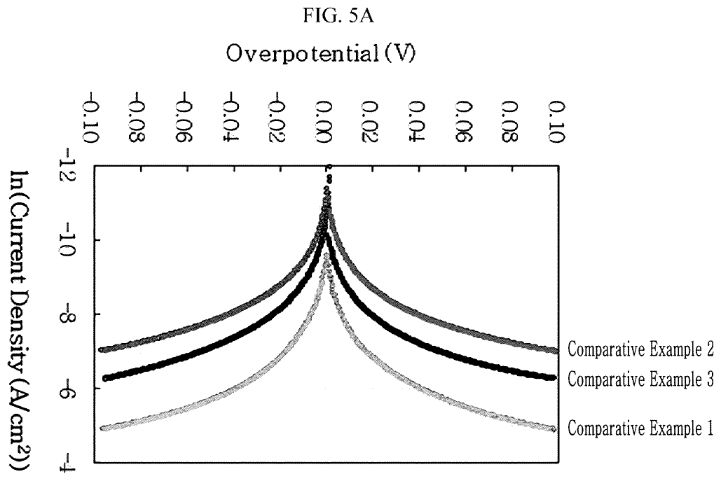

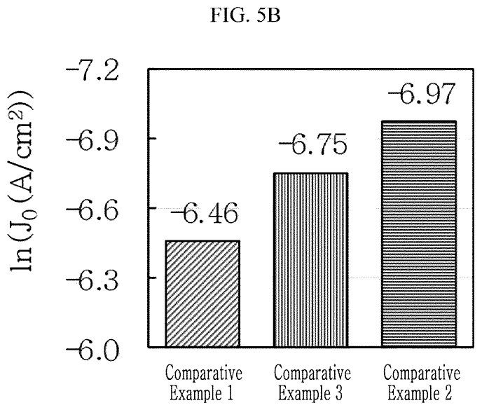

(2) Accordingly, when 1,2-dimethoxypropane (DMP) is added as a cosolvent, an experiment can analyze whether the side reaction of the FSI salt can be reduced. The cosolvent could also react with lithium, reducing the effect of the DMSF and causing the depletion, and as such this activity was checked and subjected to Tafel analysis *. The results are depicted in FIG. 5A. Experimentally, a lithium symmetric cell was configured to measure a current generated when ±0.1 V was applied thereto by using cyclic voltammetry, with a lithium foil in which lithium was electrodeposited to be 20 μm thick on Cu was punched to 16 pi and 14 pi, and using a PE separator (18 pi) coated with aluminum oxide on both sides. 10 μL of the electrolyte was injected by using a micropipette. The cyclic voltammetry was measured by applying a voltage from 0 V relative to OCP and cycling between-0.1 V to +0.1 V at a speed of 1 mV/s. From the 50th cyclic voltammetry, overvoltage and current density generated therefrom were read to plot a Tafel graph, wherein an x-intercept was defined as exchange current density.

(3) An increase in surface area arising from chemical side reaction and dendrite growth on the electrode surface was quantified by exchange current density denoted by J₀, and is shown in FIG. 5B. Referring to FIG. 5B, the electrolyte of Comparative Example 2 including only a cosolvent exhibited exchange current density of −6.97, and was more negative than the −6.46 value for the electrolyte of Comparative Example 1, using DMSF alone. Also, that value (−6.97) was a more negative than the −6.78 value for the electrolyte of Comparative Example 3, using a 1,2-dimethoxyethane solvent, which was generally known to be stable to a lithium metal. This suggests that low lithium surface area and low interface resistance are achieved under hyper-concentrated solution conditions, and confirmed excellent lithium stability of the 1,2-dimethoxypropane (DMP).

(4) Finally, the data confirmed that the 1,2-dimethoxypropane (DMP) had a minor side reaction with lithium, when applied as a cosolvent, and continuously contributed as the cosolvent, and that it did not inhibit reactivity of the N,N-dimethylsulfamoyl fluoride (DMSF).

### Confirmation of Amount of Cosolvent

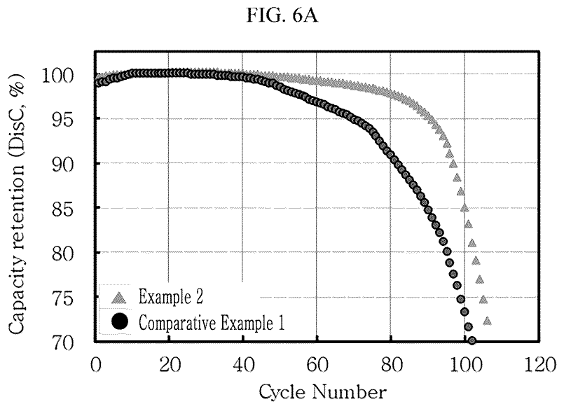

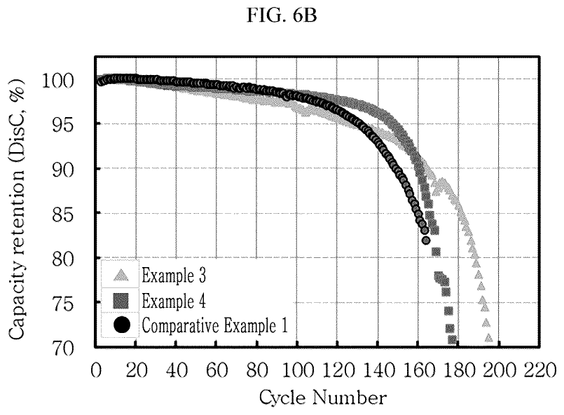

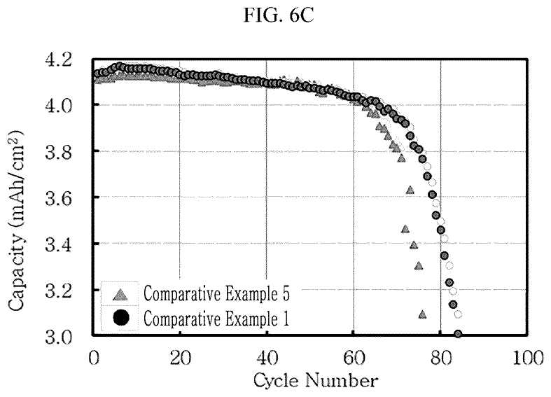

(1) Examples 2 to 4, having electrolytes including 1,2-dimethoxypropane (DMP) in an amount capable of securing improved durability, (i.e., in each amount of 66 mol %, 49 mol % and 24 mol % based on the total solvent), exhibited improved durability of 7%, 12%, and 3%, relative to Comparative Example 1. This can be confirmed observed in FIGS. 6A and 6B.

Comparative Example 5, having an electrolyte including a small amount (5 mol %) of 1,2-dimethoxypropane (DMP), exhibited reduced durability (by 7%) relative to Comparative Example 1, and is shown in FIG. 6C.

Comparative Example 6, having an electrolyte including a large amount (76 mol %) of 1,2-dimethoxypropane (DMP), exhibited reduced durability (by 7%) relative to Comparative Example 1, and is shown in FIG. 6D.

(4) The data also confirmed that the 1,2-dimethoxypropane (DMP) cosolvent, when incorporated within an amount of 24 mol % to 66 mol % based on the total solvent, was consistently able to improve durability.

### Confirmation of Amount of Salt in Electrolyte

(1) The electrolyte of Example 5 included the same amount of 1,2-dimethoxypropane (DMP) as Example 1, but modified the molar ratio of the salt to the solvent, which was lowered to 2.0 from 2.5, in order to increase a concentration of the salt in the electrolyte. The salt concentration of the electrolyte arising from excess salt was 4.8 M, which was higher than that (3.9 M) of Example 1 as well as that (3.4 M) of Example 2; however the salt precipitated at higher concentration.

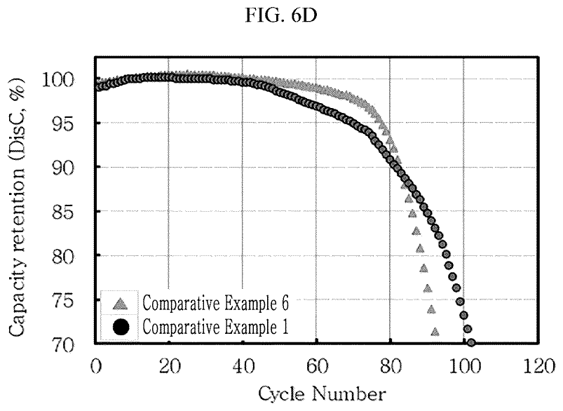

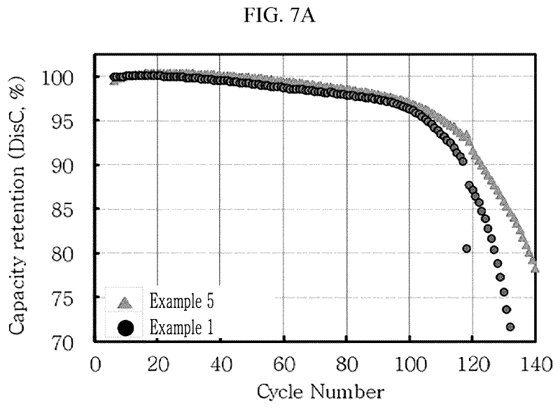

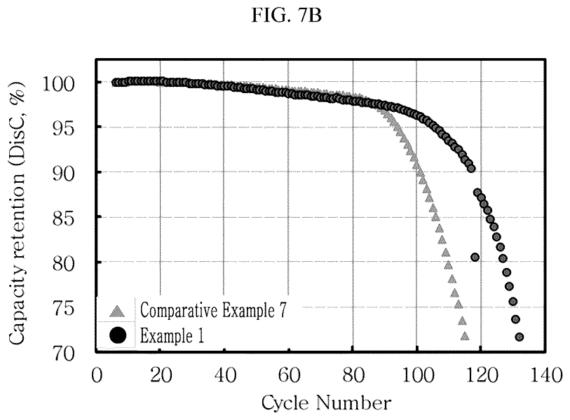

(2) Example 5 exhibited improved durability (by 8.6%) relative to that of Example 1 (128 times). This can be observed from FIG. 7A. This suggests that the excess salt was dissolved by introducing the 1,2-dimethoxypropane (DMP) cosolvent, and which can account for the improvement in the durability characteristics of the battery.

(3) The electrolyte of Comparative Example 7 includes the same amount of 1,2-dimethoxypropane (DMP) as Example 1, but with an increase in the molar ratio of the solvent to the salt, (to 3.0 from 2.5) to reduce the salt concentration in the electrolyte. This provides a salt concentration of 3.2 M, lower than that (3.9 M) of Example 1, and that (3.4 M) of Example 2. As such Comparative Example 7 includes a smaller amount of salt than both Examples 1 and 2.

(4) Comparative Example 7 exhibited a durability effect that deteriorated by 14% relative to Example 1 (128 times). This can be seen in FIG. 7B.

(5) The data also confirmed that when a molar ratio of lithium salt and non-aqueous organic solvent was maintained within a range of 1:2 to 1:2.5 in an electrolyte for a lithium metal battery, battery durability improved.

### Confirmation of Composition of Cosolvent

(1) The electrolyte compositions of Examples 6 and 7 and Comparative Examples 8 to 10 were prepared by adding an ether-based solvent (at 49 mol %) with a similar structure to that of the 1,2-dimethoxypropane (DMP), representative of a cosolvent falling within the scope of these working examples and embodiments.

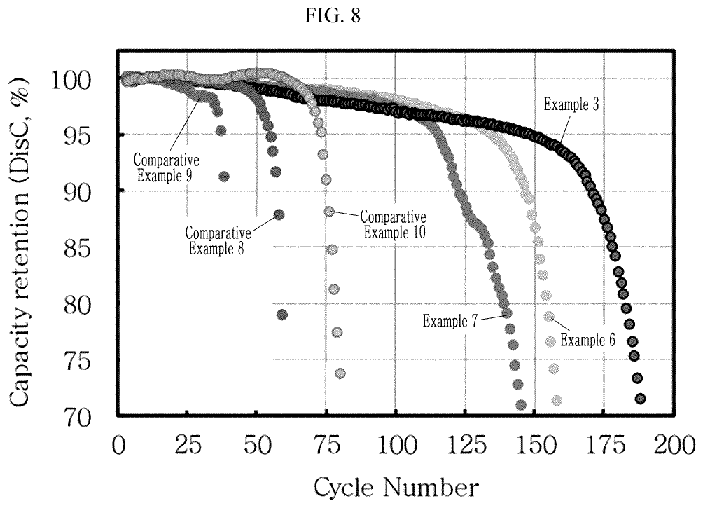

(2) Evaluating durability, Examples 6 and 7 exhibited similar long-term cycle-life characteristics to Example 3, but Comparative Examples 8 to 10 exhibited relatively earlier deterioration in durability. This can be observed in FIG. 8. The lithium metal battery cells including the electrolytes of Examples 3, 6, and 7 and Comparative Examples 8 to 10 (respectively) were evaluated with for durability, with the results shown in Table 5.

TABLE 5

| | | | Durability |
|---|---|---|---|
| | | | characteristics |
| | Cosolvent | Structural formula | (times) |
| Example 3 | 1,2-Dimethoxypropane | 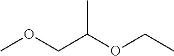 | 183 |
| Example 6 | 1-ethoxy-2-methoxy- propane | 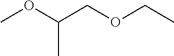 | 155 |
| Example 7 | 2-ethoxy-1-methoxy- propane | 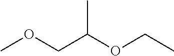 | 139 |
| Comparative Example 8 | 1,2-dimethoxybutane | 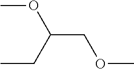 | 59 |
| Comparative Example 9 | 1,2-diethoxypropane | 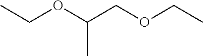 | 41 |
| Comparative Example 10 | 1,2-dipropoxypropane | 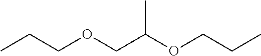 | 79 |

(3) The above results can be rationalized based on the good results associated with 1,2-dimethoxypropane (DMP), typically exhibiting a favorable dissolution environment, and lithium stability. As such, the data shows that when either one of two methoxy groups was substituted with an ethoxy group, durability remained excellent, as expected.

(4) The data also confirmed that when N,N-dimethylsulfamoyl fluoride (DMSF) was used as a main solvent, it was particularly favorable to include a cosolvent of Chemical Formula 1.

Although some preferred embodiments have been described above, the present disclosure is not limited thereto, and various modifications may be made within the scope of the detailed description, the claims and their equivalents, as well as the attached drawings.

What is claimed is:

1. An electrolyte for a lithium metal battery, comprising
a lithium salt; and
a non-aqueous organic solvent;
wherein the non-aqueous organic solvent comprises a main solvent and a cosolvent,
wherein the main solvent comprises N, N-dimethylsulfamoyl fluoride, ethylene carbonate, diethyl carbonate, dimethyl carbonate, ethyl methyl carbonate, 1,2-dimethoxy ether, dipropyl ether, cyclic sulfonamide, or a combination thereof, and
the cosolvent has a structure comprising Chemical Formula 1: 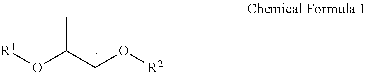
wherein,
R¹ and R² are each independently a methyl group or an ethyl group, provided that R¹ and R² are not both ethyl groups.

2. The electrolyte of claim 1, wherein
the main solvent is N, N-dimethylsulfamoyl fluoride, and
R¹ and R² are each independently a methyl group.

3. The electrolyte of claim 1, wherein
the cosolvent is included in an amount of 24 mol % to 66 mol % based on a total amount of the non-aqueous organic solvent.

4. The electrolyte of claim 1, wherein
the lithium salt and non-aqueous organic solvent have a molar ratio of 1:2 to 1:2.5, respectively.

5. The electrolyte of claim 1, wherein
the lithium salt comprises at least one of Lithium bis(fluorosulfonyl)imide (LiFSI), Lithium (fluorosulfonyl) (nonafluorobutanesulfonyl)imide (LiFNFSI), and/or Lithium bis(trifluoromethanesulfonyl)imide (LiTFSI).

6. The electrolyte of claim 1, wherein
the lithium salt is in a concentration range from 3.0 M to 5.0 M.

7. A lithium metal battery, comprising
a positive electrode;
a lithium metal layer as a negative electrode facing the positive electrode;
a separator interposed between the positive electrode and the negative electrode; and
the electrolyte for the lithium metal battery of claim 1.

8. The lithium metal battery of claim 7, wherein
the lithium metal layer has a thickness of 5 μm to 50 μm.

9. The lithium metal battery of claim 7, wherein
the positive electrode comprises a lithium-nickel-manganese-cobalt-based metal oxide.
